(19) United States
(12) Patent Application Publication
(10) Pub. No.: US 2010/0148928 A1
(43) Pub. Date: Jun. 17, 2010

(54) PAYMENT SKIN WITH CONTACTLESS CHIP

(75) Inventors: C. Douglas Yeager, Knoxville, TN (US); Adam J. Landrum, Greenville`, SC (US)

Correspondence Address: LUEDEKA, NEELY & GRAHAM, P.C., P O BOX 1871, KNOXVILLE, TN, 37901, US

(73) Assignee: MOBILE PAYMENT SKINS LLC, Knoxville, TN (US)

(21) Appl. No.: 12/636,165

(22) Filed: Dec. 11, 2009

Related U.S. Application Data
(60) Provisional application No. 61/201,668, filed on Dec. 15, 2008.
(60) Provisional application No. 61/206,090, filed on Jan. 28, 2009.
(60) Provisional application No. 61/206,881, filed on Feb. 6, 2009.
(60) Provisional application No. 61/273,482, filed on Aug. 6, 2009.
(60) Provisional application No. 61/277,929, filed on Oct. 2, 2009.

(51) Int. Cl. H04Q 5/22; G06K 19/00; B32B 38/04; B32B 38/10

(52) U.S. Cl. 340/10.1; 235/488; 156/256

(57) ABSTRACT

An apparatus is provided for making contactless card transactions, specifically of the secure element payment application variety, adapted for use in, but not limited to a customized and personalized skin that is applied to various mobile devices. The contactless payment skin provides a customized fit to the physical design of the mobile device to which it is applied. Customized graphics or images may be imprinted on the payment skin. The contactless payment skin is affixed to that mobile device. The contactless payment skin contains a contactless card region that houses an antenna and a secure element (SE) chip that may be used for contactless payment transactions at a merchant point of sale reader.

### CROSS REFERENCES TO RELATED APPLICATIONS

This patent application claims priority from and is related to U.S. Provisional Patent Application Ser. No. 61/201/668 filed Dec. 15, 2008 entitled “A Method and Apparatus for a Customized Payment Skin,” and U.S. Provisional Patent Application Ser. No. 61/206,090 filed Jan. 28, 2009 entitled “A Method and Apparatus for On-demand Personalization of Payment Skin,” and U.S. Provisional Patent Application Ser. No. 61/206,881 filed Feb. 6, 2009 entitled “A Method and Apparatus for On-demand Personalization of Payment Skin,” and U.S. Provisional Patent Application Ser. No. 61/273,482 filed Aug. 6, 2009 entitled “An Apparatus for A Payment Skin,” and U.S. Provisional Patent Application Ser. No. 61/277,929 filed Oct. 2, 2009 entitled “An Apparatus for A Payment Skin.” Provisional Patent Application Ser. No. 61/201/668, Provisional Patent Application Ser. No. 61/206,090, Provisional Patent Application Ser. No. 61/206,881, Provisional Patent Application Ser. No. 61/273,482, and Provisional Patent Application Ser. No. 61/277,929 are incorporated by reference in their entirety herein.

### FIELD

This disclosure relates to the field of payment methods using secure element microchips. More particularly, this disclosure relates to mobile devices having secure element microchips.

### BACKGROUND

In some payment technologies a microchip referred to as a “secure element” (SE) is embedded into a payment card (often referred to as a “smart card,” or into a payment “fob,” or into other devices that may be used for making payments. For the purpose of simplifying language in this document, the device that houses these form factors for secure elements will be referred to as a payment card. The secure element is attached to an antenna that is tuned for 13.56 MHz RFID (radio-frequency identification) transponders and when the secure element is presented to an appropriate “interrogator” at a merchant point of sale terminal, the secure element is recognized by the interrogator as a microprocessor and the interrogator and the secure element exchange data using standardized 13.56 MHz RFID protocols.

In order to extract information from the secure element the interrogator, also referred to herein as a “reader,” communicates wirelessly with the secure element The communication and protocol exchanged between the reader and the secure element typically follows standards established by the International Organization for Standards (referred to as “ISO” standards) and application specifications established by application providers. Some examples of ISO standards at the time of writing this document are ISO 14443A/B part 1, part 2, and part 3, and ISO 14443 part 4. Some examples of applications available for RFID payment cards at the time of writing this document are MasterCard's PayPass—Mag Stripe (V3.3), American Express PIPS ALIS v1.7, and Visa Contactless Payment Specification 2.0.1 Final. Both the reader and the secure element should be compliant to these ISO standards and application specifications to properly function with one another. The reader and the secure element are programmed with software or firmware that executes on each one respectively using technology that follows these ISO standards and application specifications. These technologies are often referred to in the art by such terms as “RFID”, “contactless,” “tap and pay”, “tap and go,” and “PayPass™” technologies. For simplicity, cards and readers that follow these ISO standards and payment applications are referred to as “contactless” or “contactless payment reader” or “contactless payment card” in this document.

Generally, payment cards are personalized for each card holder. They are typically embossed and encoded with information on them that is specific to the card holder that uses the payment card. In some instances, as illustrated by a company called Card Lab Inc. at the time of the writing of this document, payment cards may be personalized with specific graphics that may be selected or created by each individual card holder. Capital One Bank is one entity who offers this type of Card Lab services at the time of the writing of this document.

Despite the functional advantages of payment cards and fobs, they represent an extra personal item that must be carried and kept track of by a user. What are needed therefore are configurations of secure payment devices that are more convenient and better integrated into existing personal accessories that are typically already used by users for other purposes.

### SUMMARY

The present disclosure provides a method for fabricating a plurality of peel-away payment skins for a plurality of mobile devices. The method typically includes a step of compiling a first database portion of payment skin options. The first database portion may include a plurality of skin outlines where each skin outline is associated with at least one of the plurality of mobile devices, and a plurality of skin graphics where each skin graphic is associated with at least one of the plurality of skin outlines, and a plurality of contactless transaction element boundaries where each contactless transaction element boundary is associated with at least one of the plurality of skin outlines. The method further typically comprises compiling a second database portion of a plurality of payment skin orders, where each payment skin order includes a recipient indicator and a payment skin order indicator. Typically each payment skin order indicator is associated with one of the payment skin options in the first database portion.

A method for fabricating a plurality of peel-away payment skins also typically includes a step of laying out a pattern comprising a plurality of payment skin imprints, where each skin imprint is associated with one of the payment skin order indicators in the second database portion and represents the skin outline and the skin graphic in the first database portion that is associated with that payment skin indicator. Methods generally proceed with a step of printing the pattern of the skin imprints on a front side of a web material with an automated printing machine and continue with cutting with an automated cutting machine a peel-away payment skin in the web material for each payment skin imprint disposed on the front side of the web material, such that each peel-away payment skin includes the payment skin outline and the payment skin graphic that is associated with that payment skin imprint. Then typically, for each payment skin imprint in the pattern disposed on the front side of the web material, the method proceeds with forming a contactless transaction element region on a back side opposed to the front side of the web material such that the contactless transaction element region conforms substantially to the contactless transaction element boundary in the first database portion that is associated with the payment skin outline that is associated with that payment skin imprint in the pattern. Methods also typically include a step of tagging each peel-away payment skin with a destination identifier that corresponds to the recipient indicator associated with the payment skin order associated with the payment skin imprint associated with that peel-away payment skin. Also typically the peel-away payment skins are separated from each other.

Also provided herein is an assembly of skins for mobile devices that includes a planar sheet material having a web first side and an opposing web second side. A plurality of peel-away payment skins is provided with each peel-away payment skin being defined by a peel-away payment skin boundary that is cut in the sheet material, where each peel-away payment skin boundary has a different geometric shape. Further, each peel-away payment skin includes a skin first side that corresponds to the web first side and a skin second side that corresponds to the web second side. A skin graphic is typically disposed within the peel-away payment skin boundary of the peel-away payment skin on the skin first side, and a contactless transaction element region is provided. The contactless transaction element region has a contactless transaction element location and a contactless transaction element boundary that is formed on the skin second side within the peel-away payment skin boundary.

Also provided herein is a payment skin for a mobile device. The payment skin includes a substantially planar substrate that has a first side and an opposing second side. There is a skin imprint disposed on the first side and a contactless transaction element cavity disposed on the second side. A secure element is disposed within the contactless transaction element cavity. A first antenna is provided for receiving and transmitting radio frequency signals comprising transaction data. The first antenna is disposed adjacent the secure element and is operatively connected to the secure element. A second antenna is disposed adjacent the first antenna. The second antenna is inductively coupled to the first antenna.

Also provided is a payment skin for a mobile device that includes a substantially planar substrate having a first side and an opposing second side. A skin imprint is disposed on the first side and a contactless transaction element cavity disposed on the second side. A secure element is disposed within the contactless transaction element cavity. There is an antenna for receiving and transmitting radio frequency signals comprising data. The antenna has a first circumscribed area and the antenna is disposed adjacent the secure element and is operatively connected to the secure element. A moderator is provided for reducing interference with the radio frequency signals. The moderator has a second circumscribed area that is at least about ten percent larger than the first circumscribed area and the moderator is disposed adjacent the antenna.

Further provided is a method of optimizing the location of a secure element having a data communication range and optimizing the location of a metallic element in a payment skin for a mobile wireless device having an antenna for reception of a radio frequency signal at a designated frequency. The method includes a step of evaluating a reduction in power of the radio frequency signal collected by the antenna at the designated frequency by testing a plurality of locations for the metallic element in the skin to establish an optimal metallic element location that minimizes the reduction in power of the radio frequency signal at the designated frequency attributable to the metallic element to determine an optimal metal element location. The method also includes a step of evaluating a reduction of the data communication range of the secure element by testing a plurality of locations for the secure element in the skin to establish an optimal secure element location that maximizes the data communication range of the secure element to determine an optimal secure element location.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIGS. 1A, 1B, and 1C illustrate an embodiment of a contactless transaction element.

FIGS. 2A and 2B illustrate an embodiment of a contactless transaction element.

FIGS. 3A and 3B illustrate a cross-section of the contactless transaction element shown in FIGS. 1A, 1B and 1C.

FIG. 4 illustrates a cross-section of the contactless transaction element shown in FIGS. 2A and 2B.

FIGS. 5A, 5B, and 5C illustrate two different embodiments of a contactless transaction element.

FIG. 6 illustrates an on-demand personalized mobile device skin.

FIGS. 7A, 7B and 7C illustrate a contactless payment skin.

FIG. 8 illustrates features of an assembled contactless payment skin.

FIGS. 9A and 9B illustrate segments of payment skin for a specific mobile handset.

FIGS. 10A and 10B illustrate the mobile handset that receives the skin illustrated in FIGS. 9A and 9B.

FIG. 11A depicts the outer surface and FIG. 11B depicts the under surface of the payment skin illustrated in FIG. 9B.

FIG. 12 illustrates a planar material for fabrication of a payment skin.

FIG. 13 illustrates graphic images for mobile devices on a planar material.

FIG. 14 illustrates programmed cut lines for a cutting machine that correspond to the graphic images in FIG. 13.

FIG. 15 illustrates the cut lines in FIG. 14 projected over the graphic images in FIG. 13.

FIG. 16 illustrates the cut lines for the back of the material transposed over the reverse image of FIG. 15.

### DETAILED DESCRIPTION

In the following detailed description of the preferred and other embodiments, reference is made to the accompanying drawings, which form a part hereof, and within which are shown by way of illustration the practice of specific embodiments of payment skins and embodiments of methods for producing payment skins It is to be understood that other embodiments may be utilized, and that structural changes may be made and processes may vary in other embodiments.

A secure element (SE) typically contains a microprocessor, random access memory (RAM), read only memory (ROM), flash memory (EEPROM), encryption engine(s), and one or more methods of interfacing the secure element with external devices.

Secure elements typically have embedded software applications configured to run on the secure element and specific card holder information is encoded into the secure element prior to its being delivered to the end user. Various provisioning entities such as First Data Corp. operate under rigid standards set forth by card associations such as VISA, MasterCard, AMEX, and others in order to keep the provisioning process secure, and to ensure that customer data is protected inside the secure element, and to ensure that only the card issuing banks or their agents are able to verify the information that is extracted from the secure element. It is generally important that standards be followed in the adaptation of secure elements to embodiments disclosed herein.

As previously indicated, in order to extract information from the application(s) on a secure element, an interrogator (also referred to as a “reader”) interacts electronically with a secure element. The applications on a secure element are accessed by a reader using specific query/response calls defined by the application provider. These applications protect the data on a secure element via encryption engines in the secure element.

A standard physical interface between a reader and a secure element is defined in the ISO 14443 specifications. The ISO 14443 specification defines a “Contactless” interface to a secure element in which the secure element is powered by an inductive field produced by an interrogator during the interrogation. The data transfer during the interrogation is managed over a 13.56 MHz carrier signal provided by an interrogator. The secure element uses an antenna in order to couple with and communicate with the interrogator. The antenna is a coil antenna for being energized electromagnetically. The size of the coil antenna varies from one card form factor to another, but in general is no smaller than ½ inch by ½ inch and is generally no larger than 3 inches by 3 inches.

For simplicity, the term “mobile device” or “mobile handset” in this document refers to a mobile wireless handset such as a cellular phone, a smart phone, a BLACKBERRY™, a PALMPILOT™, an IPHONE™, or a POCKET PC™, to name a few examples. The term “mobile device” as used herein also encompasses other hand-held devices such as an IPOD™, an MP3 music player, a mobile computing device, or other electronic hardware device that is portable and carried and accessed during daily activities.

Various mobile device manufacturers and after-market manufacturers provide “skins” that may be applied to mobile devices. These skins permit a user to customize the color, design, and appearance of their personal mobile device. The word “skin” as used herein refers to a customized sticker that has an outline that that generally matches at least a portion of the physical outline of the mobile device to which it is affixed. However, in some embodiments a skin may have an outline that is smaller than the outline of a portion of a mobile device to which it is affixed. A skin generally has one side coated with an adhesive to make it “sticky” (generally accessible by peeling off a disposable backing material), and an opposing side that is personalized with an image that the mobile device owner has selected. The “sticky” side of the skin is made to adhere or affix to the mobile device itself when the skin is applied to the mobile device.

The term “payment skin” is used herein to refer to the combination of a secure element and a skin for a mobile device. Typically the payment skin is customized specifically to the model of the mobile device to which it is intended to be affixed. Such customization generally includes matching a portion of an external outline shape and size of the payment skin to a particular section of the specific model of mobile device to which it is intended to be affixed. A portion of an external outline shape may, for example, refer to the battery cover section. Various embodiments may be delivered to the end user in a form that is specific to that end user's mobile device. The terms “personalized” and “personalization” are used herein to refer to both the shape of the skin matching the end user's specific mobile handset as well as the images on the skin displaying the selected preference of the end user. Preferably personalization of a payment skin provides the end user with selections for both graphic images as well as physical shape of a skin.

A primary use of a payment skin is to provide the capability of interacting and making payment transactions with a merchant point of sale terminal in a contactless manner. In this respect a payment skin is similar to a contactless payment card, but there are differences. For example, the steps for manufacturing payment skins are typically different from the steps for fabricating a contactless payment card. Furthermore the fulfillment process for payment skins may change from the typically payment card fulfillment process. For example, the end user may receive a secure element from one provider and a skin from a second provider and affix the secure element to a skin to provide a payment skin. The end user of a payment skin will often assemble the payment skin to a mobile device. Once the payment skin is affixed to a mobile device the payment skin may be used for the same types of transactions (such as a contactless payment at a merchant point of sale) for which a conventional payment card may be used.

Various techniques disclosed herein may be utilized for optimally combining payment card capabilities with a mobile device. One optimizing technique is to incorporate the secure element into a sticker-type arrangement that is applied to the mobile device such that the secure element is physically well-integrated with the mobile device. In order to make the sticker that is affixed to the mobile device more integral and “natural” and “matched” with the mobile device, a custom physical outline of the sticker may be created so that the sticker becomes a skin that covers a section of the mobile device. As an example, a section of a mobile device that is fairly common to most mobile devices is a plastic cover that is used to cover a battery compartment of the mobile device. The battery compartment physical shapes vary widely from mobile device to mobile device. A customized sticker skin that contains this payment card function may be delivered for each of these various mobile devices. The sticker skin typically has a physical outline that is designed specifically for each different mobile device it is intended to be used with. This becomes a significant design advantage over a non-customized sticker that is intended for general purpose usage for a variety of different mobile handsets. One design advantage is a closer integration to the mobile handset by giving an appearance of a particular mobile device. Another significant design advantage is that such customized skin typically provides a larger adhesion area where the custom sticker skin is affixed to the mobile device. The adhesion area may be larger because the customized skin may take advantage of sticking to substantially all the surface area of the particular section of the mobile device to which it is affixed. Another significant design advantage of a customized skin contactless card is that not only is the physical shape personalized to the mobile handset, but the image printed on the skin may be personalized to the card holder.

Various embodiments of payment skins described herein may be combined with further functionality such as mobile device data services that address various mobile banking applications that may be utilized with a contactless payment skin. An example of such an application is a data or text messaging service for communicating requests and responses to a central server that has access to account data from the contactless payment skin. This information may be shared with the mobile device to which the contactless payment skin is affixed. This provides a logical connection between the mobile device and the contactless payment skin that is affixed to it, thus enhancing the utility of each device.

As an example for a banking application, many mobile devices have the ability to connect and transfer data between themselves and remote computers via mobile cellular wireless transmissions. Some examples of these transmissions are SMS (Short Message Service), Text message transmissions, Data transmissions, and WAP (Wireless Application Protocol) transmissions. These technologies may be combined with the security provided by a secure element for remote query and response exchanges such as the following:
a. Mobile Device sends a text message to a remote server using keywords to request a resent transaction history for its payment skin.
b. Text message is received over the wireless cellular tower and forwarded to the appropriate receiving computer referred to as an “internet server.”
c. The internet server receives the text message banking information request and verifies the phone number the message came from, and then processes the request by requesting the resent transaction information from this account from the bank computer.
d. The bank computer responds to the internet server that then processes the response from the bank.
e. The internet server then formulates a response text message and sends it to the originally requesting phone number
f. The mobile device then receives the recent transaction information it had requested regarding the contactless payment skin that is affixed to it.

The term “contactless transaction element” is used herein to refer to a subassembly that contains a secure element microchip and may also include an antenna, a ferrite moderator, and other components. It is important to note that a contactless transaction element may not physically resemble the shape or size of a typical payment card and may come in various form factors such as a flexible sticker with a “sticky” adhesive for affixing the contactless transaction element to a mobile device. A contactless transaction element is typically fabricated as a laminated structure. In most embodiments the contactless transaction element is affixed to a skin and the resulting payment skin is affixed to a mobile device, such that the contactless transaction element is between the skin and an outside surface of the mobile device. The skin is typically made from a vinyl material that is designed to mold and shape itself over any surface it is affixed to. So, by being affixed to a contactless transaction element, the skin will also mold over the surface of the contactless transaction element, including the edge of the region, giving an embossed look to the mobile device skin itself. It is an advantage to have a thinner constructed contactless transaction element for assembly to the mobile device skin in order to have a less dramatic edge show through the mobile device skin. If a contactless transaction element is tapered toward its edges the resulting payment skin has a very thin edge. This is advantageous because it reduces the likelihood that an edge of the payment skin will snag on things under normal use of the mobile device to which the payment skin is attached. At the same time the edge of the contactless transaction element is visible on the top-side of the mobile device skin. This is advantageous to help the user position the payment skin at the proper location for communication with a reader.

The term “on-demand personalization of a payment skin” is used herein to refer to a particular process of creating a contactless payment system that typically has two basic customizations for each recipient:
a. The graphics that are printed on the skin are selected by the individual recipient. Examples of graphics printed on each sticker may include logos from sports teams, independent designs, photographs of friends or family members, etc.
b. The physical outline of the payment skin that is provided to each individual recipient is based upon that recipient's mobile device model.

The process of on-demand personalization may take place as follows:
a. A person ordering a personalized mobile device skin uses a web browser to select the type of mobile device the skin will be applied to from an electronic order form that is be provided by an ordering system on the internet.
b. The person selects graphics to be printed to the mobile device skin.
   1) The person may upload or add their own personal graphics to the fulfillment system by loading images through an internet browser.
   2) The person may select individual graphics or images that are pre-created and exist in a library and are selectable through an internet browser
c. The person then typically confirms both graphics and mobile device model prior to submitting order for creation and fulfillment of mobile device skin.
d. An order is then accepted by the ordering system and is dispatched to a fulfillment area that receives, prints, and cuts adhesive skin specific to recipient's request.
e. The skin elected by the person is then shipped to the person.

In many embodiments the process of fabricating payment skins for different mobile devices in an on-demand environment involves compiling a first database portion, where the first database portion defines different payment skin options. Typically the first database portion includes:
(1) a number of different skin outlines where each skin outline is associated with at least one of the different mobile devices,
(2) a number of different skin graphics where each skin graphic is associated with at least one of the different skin outlines, and
(3) a number of different contactless transaction element boundaries where each contactless transaction element boundary is associated with at least one of the different skin outlines.

The process of fabricating payment skins for different mobile devices in an on-demand environment typically also involves compiling a second database portion, where the second database portion records payment skin orders received from customers. Typically each payment skin order includes a recipient indicator and a payment skin order indicator where each payment skin order indicator is associated with one of the payment skin options in the first database portion. The identifiers “first database portion” and the “second database portion” are provided for comparative reference purposes herein, and are not intended to convey database structural information. In some of the elements one database portion may actually (electronically) reside concomitantly with the other database portion. For example, if the on-demand system permits a customer to upload graphics for inclusion on the payment skin, that skin graphic may be stored in the second database portion instead of the first database portion, which in some embodiments might store only “stock” skin graphics. Furthermore, the two database portions may actually (electronically) reside in a single database. Typically the two database portions reside on a digital storage medium such as a computer hard drive, and are accessed by a computer.

In some embodiments an opportunity may be provided for the person ordering a personalized mobile device skin to submit an application for a credit account, a debit account, or other authorization-type account as part of the process of ordering a personalized mobile device skin. In such embodiments, if the person's authorization application is accepted, a secure device may be created under a contactless transaction element personalization process. Contactless transaction element personalization typically involves injecting payment credential data into a secure element portion of a contactless transaction element. This payment credential data typically includes a PAN (Primary Account Number), an expiration date, the card holder name, bank discretionary data, security keys, and any other information specific to the bank or card holder of this particular credential. The personalized contactless transaction element for the person ordering a payment skin is then assembled with the personalized mobile device skin for shipment to the person.

In some embodiments the personalized mobile device skin may be configured to accept a standardized secure element/contactless transaction element from a payment card and then the person receiving the personalized mobile device skin may affix that standardized secure element/contactless transaction element to the personalized mobile device skin.

On-demand personalization of a skin provides an advantage that is apparent to many users because many users consider their mobile device to be something that reflects some aspect of their personal life-style preferences. On-demand personalization enhances this aspect of a mobile device ownership experience for its owner.

In most embodiments the process for fabricating a payment skin includes one step of fabricating a skin without a contactless transaction element in a skin fabrication facility and another step of fabricating a personalized contactless transaction element in a separate facility. Then both objects are received and matched up and assembled. As previously indicated, this matching may be done in a production operation prior to shipment to the end user, or the separate objects may be shipped to the end user who then assembles them into a payment skin and applies them to a mobile device.

A payment skin typically includes two particular elements.
a. A personalized contactless transaction element, which includes a secure element micro-chip bearing personalized credential information and having an internal antenna, and may also include such other elements as an external antenna, filler material, a ferrite moderator, a base substrate, and outer coatings.
b. An on-demand personalized device skin, which includes an outline shape that is specific to the mobile device to which it will be attached, on-demand personalized graphics printed to a vinyl layer, an over-laminate layer that protects the vinyl substrate and the printed graphics, a contactless transaction element cavity for aligning positioning the personalized contactless transaction element, and adhesive on the reverse side of the vinyl substrate that allows the vinyl layer to be affixed to a mobile device

Payment skins are typically customized for a particular mobile device, first because different mobile devices have different shapes and second because of important electronic compatibility issues. Many mobile devices are mobile phones that use wireless communications to communicate voice or data signals to wireless towers. These mobile handsets use antenna technology to emit and receive signals. Today, there are a number of different technologies used including Global System for Mobile communications (GSM) or code division multiple access (CDMA) technologies. Both of these technologies and their performance are dependent on their environment and how they are designed into their housing and mobile handset itself. In short, the antenna placement of the mobile handset it important to the performance of the antenna.

Combining a contactless transaction element to the outside of a mobile device may affect the performance of the wireless communication of the mobile handset with wireless towers. For this reason, some analysis should be done and strategy considered in order to place the contactless transaction element in the appropriate place on the outside surface of the mobile handset so as to interfere as little as possible with mobile handset wireless communication function. As little as one cm location change in one direction or another for placement of the contactless transaction element may make a significant difference with interfering with the wireless communication signal of the mobile handset. Specifically, the metal areas of the contactless transaction element are the areas that may cause a problem with the wireless antenna of the mobile handset. The ferrite moderator is one specific metallic area of the contactless transaction element that may have an impact on this. To minimize interference between the contactless transaction element and a mobile device it is generally very important to carefully evaluate the placement of the contactless transaction element within the entire skin relative to the mobile device to which the skin is being applied.

Similar to the way in which the wireless communication antenna of a mobile handset may be affected by its environment, the performance of a contactless transaction element may be affected by its environment and specifically may be affected by the mobile device to which it is affixed. In fact, the location of a contactless transaction element with respect to the mobile device may significantly affect the communication range of the contactless transaction element with an RFID interrogator. A particular example of this generally occurs if the mobile device has a metal material as part of its casing like the original IPHONE™ made my Apple Inc. The metal backing of the mobile device generally affects the reading range of an external interrogator that is attempting to communicate with the contactless transaction element that is affixed to such a mobile device. In this specific example, it is generally advantageous to place the contactless transaction element close to the edge of the mobile device to ensure as little of the metal of the mobile device enters the field of the contactless interrogation device (RFID reader) as possible. This may allow for a longer reading range of the contactless transaction element. Other features of the mobile handset may be important to consider when determining the proper location to place the contactless transaction element in or on the vinyl skin. Some of these features are large areas of copper on the circuit board which create a large metal area that may affect the reading signal by de-tuning the contactless transaction element.

It is often desirable to optimize both the location of a secure element and the location of a metallic element in a payment skin for a mobile wireless device. That is, a secure element typically has a data communication range and it is beneficial to position the contactless transaction element in a position on the mobile device that helps maximize the communication range. Also, mobile devices typically have an antenna for reception of radio frequency power at a designated frequency and it desirable to position any metallic elements in a payment skin at a location that helps minimizes the attenuation of the radio frequency power as little as possible.

Often a process for optimizing the location of a metallic element in a payment skin involves evaluating a reduction of the radio frequency power collected by the antenna at the designated frequency by testing a plurality of locations for the metallic element in the skin. This step is typically performed on a “trial and error” basis to establish an optimal metallic element location that minimizes the reduction of the radio frequency power at the designated frequency attributable to the metallic element.

Often the process for optimizing the location of the secure element in a payment skin involves evaluating a reduction of the data communication range of the secure element by testing a plurality of locations for the secure element in the skin. This step is typically performed on a “trial and error” basis to establish an optimal secure element location that maximizes the data communication range of the secure element (i.e., minimizes the reduction of the data communication range).

Sometimes a tradeoff may be necessary between (a) optimizing (minimizing) the reduction of the radio frequency power collected by the antenna of the mobile device and (b) maximizing the data communication range of the secure element in a payment skin. In such circumstances it is generally preferred to first perform the process that optimizes the less important parameter and then performing the steps for the more important parameter. That is, if minimizing the reduction of radio frequency power collected by the mobile device is the more important consideration, it is generally advantageous to first perform the steps for optimizing the location of the secure element in a payment skin and then after that to perform the steps for optimizing the location of a metallic element in a payment skin. If maximizing the data communication range of the secure element is the more important consideration then it is generally advantageous to first perform the steps for optimizing the location of a metallic element in a payment skin first and then to perform the steps for optimizing the location of the secure element in a payment skin. Sometimes it may be beneficial to iterate these steps several times, concluding with the steps that optimize the more important parameter.

As previously indicated, many payment skins are typically formed from vinyl material. Typically the payment skin is fabricated as a flat material (i.e., a “planar substrate”) that is sufficiently pliant to conform to the contour of the mobile device to which it is affixed. Such a payment skin may be referred to as a “contoured” skin herein even though its shape as-fabricated is planar.

Many embodiments employ the combination of (a) a contoured vinyl adhesive skin that generally conforms to a physical outline feature of a mobile device with (b) a contactless transaction element that is specifically placed within or under the vinyl skin at a location that optimally aligns and locates the contactless transaction element with respect to the mobile device design. This combination of (a) and (b) may be used to optimize the mobile device antenna for communication of its mobile signal with a wireless tower as well as to maintain optimal performance of the contactless transaction element with an external interrogator (RFID reader).

In embodiments where a payment skin is provided to a user for application to the user's mobile device, it is desirable to provide intuitive indications of the correct orientation and position of the contoured vinyl adhesive skin to the consumer who is responsible for applying the vinyl skin to their mobile device. This may be done, for example, by providing a skin having an outline that is a polar, (i.e., an outline that can only be applied to the mobile device in one location that is intuitive to the consumer because the shape of the skin closely resembles the outline of the mobile device to which it is applied. Such intuitive indicators help ensure that the contactless transaction element is correctly fitted or affixed with the skin to the mobile handset in the appropriate place. This is advantageous because it reduces the amount of written instructions that may be provided to the user and reduces user confusion and mistakes when applying a payment skin to a mobile device.

In many embodiments the physical outline of the mobile device skin is cut out of a web material. The term ‘web material’ as used herein refers to a material having a sheet-like structure, which may be formed from one or more layers of film, and/or foil, and/or woven fibers, and/or entangled fibers, or the like. Typically the web materials used in embodiments disclosed herein are multi-layered materials. Generally the web material includes a printable layer with printable regions on a web first side and a backing material that forms a web second side opposing the web first side. An adhesive layer is typically provided between the printable layer and the backing layer to laminate those two layers together.

The process of manufacturing a skin typically includes a printing and sealing operation that may include the following steps:
a. Printing custom graphics on printable regions of the printable layer. An example of a printable layer material is product number IJ180 vinyl material made by 3M Corporation. The vinyl material includes both an adhesive and an adhesive backing that may be removed from the vinyl prior to application of the skin to a mobile device. The vinyl layer generally is approximately two thousandths of an inch thick. It is a material that has some main features that include:
   1) Designed to be printed on, possibly with ink jet printing technology.
   2) Designed to be malleable so that it can conform to the surface to which it is applied.
   3) Designed with COMPLY™ adhesive that allows it to be applied and then reapplied or repositioned during application.
   4) Designed with a backing that is intended to be removed from the vinyl during application.
b. After custom graphics are printed on the IJ180 vinyl substrate, another layer is typically applied over the top of the newly-printed vinyl. This layer is called an over-laminate. The over-laminate is a thin, transparent material intended to protect the printed vinyl from the environment as well as make the overall composite more durable. The over-laminate is generally approximately two to four thousandths of an inch thick. The over-laminate that is often applied to IJ180 vinyl from 3M is product number 8519 over-laminate from 3M.

The contactless transaction element is placed in a “contactless transaction element region” within the contoured outline of a payment skin. A contactless transaction element region is a portion of the payment skin that is designated by physical contouring or labeling for the placement of a contactless transaction element. In preferred embodiments, the contactless transaction element region is strategically located based on various mobile device properties. Because small errors in the location of a contactless transaction element region may significantly degrade performance of the secure element and/or performance of the mobile device, it is important to design an efficient method of manufacturing for this process that is programmable and repeatable for each mobile device.

One method that facilitates such accuracy and efficiency is a process called contour cutting or “kiss-cutting.” This process is typically performed by a robotic machine that has the ability to cut only through a portion of the thickness of a material along a programmable cutting path. For example, a kiss cutting machine may cut through the over-laminate and the vinyl layer of a skin while leaving the backing material intact. The electronic cutter may be used to cut the outline of the vinyl and over-laminate in a cut that closely matches the outline of the mobile device it will be affixed to. Generally kiss-cutting machines use drag knife to cut the material, but other cutting mechanisms such a laser beams may be used. This process leaves the backing material intact and allows the final skin to be easily peeled from the backing and applied to the designated mobile device by the recipient. For example, in kiss-cutting, a knife blade penetrates both the over-laminate and vinyl layers in order to contour cut the shape or pattern of the design to match the surface it is being applied to. In this case, the backing material is still intact and continues to act as a substrate to hold the vinyl until it is removed for application. Such a payment skin is an example of a “peel-away payment skin.” A peel-away payment skin is a payment skin that has the backing material affixed to it. The kiss-cutting process allows the consumer to peel the contoured vinyl away from the backing material and apply the skin to the mobile device. After kiss-cutting, individual peel-away payment skins are separated from each other by a sectional thru-cutting process. That is, the web material is cut into sections with each section comprising one payment skin.

Another type of peel-away payment skin may be formed by cutting the outline of the skin entirely through the web material except for intermittent connecting points, such that a perforated cut is formed. This permits further processing of a plurality of payment skins in the web material before each individual payment skin is punched out along the perforated cut line, which conforms to the outline of the skin that will be applied to a mobile device. The combination of kiss-cutting and sectional cutting is generally preferred over this latter process of perforation cutting because the latter process leaves serration artifacts along the edge of the peel-away payment skin.

In some embodiments a peel-away payment skin may include multiple segments. For example some segments may be configured for application on the front surface of a mobile device and other segments may be configured for application to the back surface of that mobile device. Often only one segment contains a contactless transaction element region. The combination of segments may be provided to enhance the overall integrated appearance of the payment skin when it is applied to a mobile device.

Kiss-cutting may also be used to form the contactless transaction element region in a payment skin. One such embodiment provides both proper alignment as described above and the ability to affix the contactless transaction element to a payment skin without peeling back the vinyl contour to place the contactless transaction element under the vinyl material. This process may involve reversing or “flipping” the web material (which includes a backing material, the vinyl and an over-laminate) prior to feeding the web material into an automated kiss-cutting machine to form a contactless transaction element region. This orientation of the web material results in kiss cutting a contour in the backing of the material while leaving the vinyl and over-laminate intact. In this arrangement the backing of the material is facing toward the cutting knife and as the cutting knife contracts the web material to cut, the kiss-cutting knife cuts through the backing material to form a contactless transaction element region, but leaves the vinyl and over-laminate un-cut. That is, this process of setting up the automated kiss-cutting machine cuts only the backing material to form the contactless transaction element region. The backing may then be peeled back to expose a contactless transaction element cavity adjacent the vinyl. This peeling back of the backing material is an example of accessing a contactless transaction element region. By peeling back only the backing material covering the contactless transaction element region the contactless transaction element may be accurately and easily affixed to the vinyl material without peeling back the backing material from the entire payment skin.

Instead of first kiss-cutting the outline of the vinyl and over-laminate to form a skin peel-away and then reversing or flipping the web material to form the contactless transaction element region in a payment skin with the same kiss-cutting machine, two kiss-cutting systems operating in opposing directions may be used. In such embodiments one system is used for kiss-cutting the over-laminate and the vinyl to cut the outline of the skin and the second kiss-cutting system to cut the backing material and form the contactless transaction element region of a payment skin. These kiss-cutting methods (either the flipping method or the two system method) provide for a programmable and repeatable alignment of the contactless transaction element in a skin with respect to the mobile device to which the skin is affixed. After the backing is cut, the contactless transaction element may be properly positioned by locating and peeling back the contoured cut out region and placing the contactless transaction element in that area. This kiss-cutting process for forming a contactless transaction element region may also be supplemented with a process for embossing (indenting) a portion of the vinyl material to form a recessed cavity for a contactless transaction element.

Cutting machines typically align themselves to pre-printed material by using reference mark methods that may include manual and/or automatic methods. A manual method may query the operator of the machine to locate various markings on the print that indicate a position of the entire print relative to the cutting machine coordinate system. An automatic method may use an optical sensor on the cutting machine to locate reference marks that indicate a position of the entire print relative to a cutting machine coordinate system. Once the cutting machine has located the reference marks it performs the contour or kiss-cutting operation for cutting the contour of each mobile device design into the material. Because each of the skins has a region within its outline that is fitted with a contactless transaction element, it is important that reference marks on the vinyl side of the material be referenced from the reverse or “flip” side of the material in order to provide accurate contour cutting of each contactless transaction element in the backing material during the second cutting procedure. This referencing may be accomplished in a number of ways. One way is to have the cutting machine make “slit” through cuts into the reference marks so that they are visible on the reverse or “flip” side of the material. This slit cut may also be done manually with an XACTO™ or similar knife blade. After this step, reference marks are then visible on the reverse or “flip” side of the material (the backing) These marks may be exaggerated with an ink pen or something similar so that they may be seen more easily by a human operator and/or by the optical sensor of the cutting machine. At that point, when the material is then typically fed into the cutting machine with backing side up, the material is properly aligned and discovered with either manual or automatic alignment methods described above. Thereafter a programmatic contour cutting tool may perform the contour cutting of each contour for each of a plurality of contactless transaction element regions on a single print, which is aligned with each contour cut on the front of the print material for each of the plurality of skins.

In many embodiments relief cuts may be provided within each contour or kiss-cut outline for a mobile device. Such relief cuts facilitate the placement of a thicker contactless transaction element under the vinyl substrate without “bunching” the vinyl at the corners. Vinyl and over-laminate layers are designed to be flexible and stretch to a certain extent so that they properly adhere to and “wrap” curved surfaces without wrinkling like other materials such as paper would do. However, this property of vinyl has a limit. Dramatic surface contour changes may still cause wrinkle problems for vinyl material. If a contactless transaction element is a thicker material with vertical walls, for example, 0.03″ thick in comparison to vinyl and over-laminate composite of 0.004″ thick, and there is a sharp or rounded corner of the contactless transaction element that may be 90 degrees, it is desirable that the vinyl adhere to and cover the contactless transaction element like a coating without wrinkling or showing visible stress marks in the covering vinyl material. Often however, with this type of geometry of a contactless transaction element it is difficult to apply vinyl material to a surface without wrinkling the vinyl. In order to facilitate the application of a vinyl covering and a contactless transaction element to a mobile device in a manner that produces a vinyl covering that is substantially wrinkle free, it may be beneficial to make relief cuts into the vinyl and over-laminate at the corners of the contactless transaction element. These cuts will allow a separation within the vinyl so that it is not wrapping or covering the contactless transaction element at the corners. These relief cuts facilitate a smooth vinyl finish without wrinkles

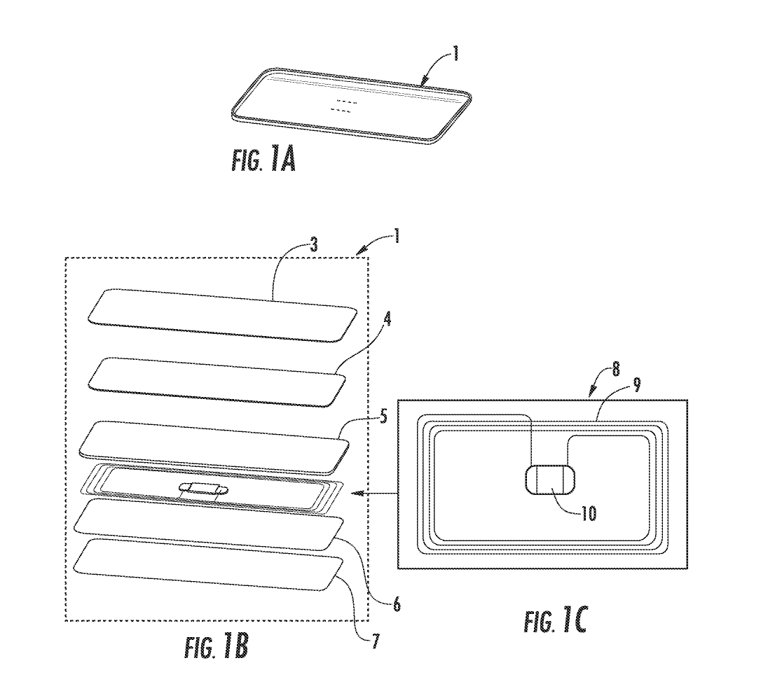

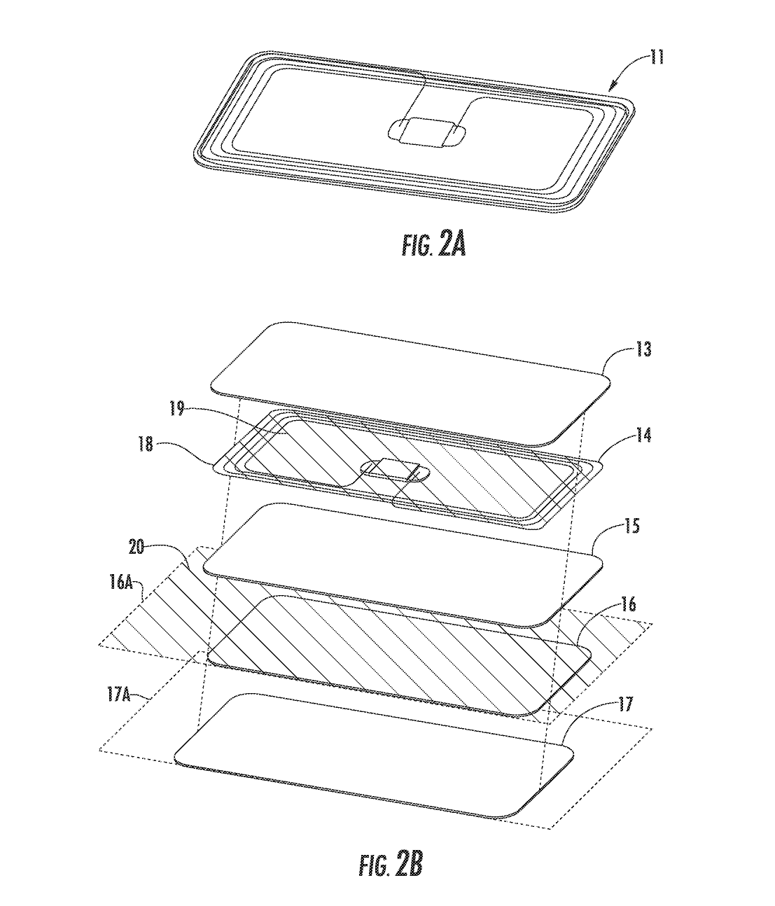

Referring now to the Figures for more specific details regarding various embodiments, FIG. 1A depicts one embodiment of a contactless transaction element 1 and FIG. 1B depicts an exploded view of the contactless transaction element 1, illustrated as follows:
a. Two thin protection coating layers 3 and 7 form the outer surfaces of the contactless transaction element 1. Each of the protection coating layers 3 and 7 are typically a couple mils (e.g., 0.002″) thick.
b. A ferrite moderator 4 may be provided to enhance the performance of the contactless transaction element when the contactless transaction element 1 is affixed to a mobile device. Because a mobile device itself (particularly metal surfaces in a mobile device) may create interference and hamper performance of the high frequency (HF) radio waves between the contactless transaction element 1 and an interrogator, it may be beneficial to include a ferrite moderator 4 to help block this interference. The ferrite moderator 4 may be a couple mils (e.g., 0.002″) thick. The term “ferrite moderator” is synonymous with the terms “ferrite shield” and “ferrite absorber” that are used in this field of art. As the name implies, the ferrite moderator 4 comprises ferrite material. Other materials may be used for the same purpose, and the term “moderator” is used herein to refer to ferrite moderators and other devices providing similar benefits.
c. A filler material 5 may be used to flatten the top of the contactless transaction element 1 after a microcircuit 8 is assembled onto a base substrate 6. This base substrate 6 may be a couple mils (e.g. 0.002″) thick. The filler material 5 establishes a substantially uniform thickness of the contactless transaction element 1, and its thickness is may be selected to establish an ISO-compliant overall device thicknesses of approximately 30 mils (0.030″) for a contactless payment card.
d. The microcircuit 8 includes a secure element chip 10 and a coil antenna 9. Typically the secure element chip 10 is first assembled to the base substrate 6. The antenna 9 is then assembled on top of the base substrate 6 and the ends of the antenna 9 are connected to interface points at the edges of the chip 10. The antenna 9 may function substantially as a magnetic coil that when coupled with a magnetic field creates a power supply for the chip 10. The antenna 9 typically also serves as a radio frequency communication antenna in a base band frequency of 13.56 MHz. The microcircuit 8 typically has a non-uniform topography such that the thickness of the microcircuit 8 varies from a few mils (e.g., 0.002″) to perhaps ten mils (e.g., 0.010″) in thickness.
e. Typically the antenna 9 is a coil made of conducting ink or made of wire. The number of turns included in the coil is determined by many factors including the specific design of the secure element chip 10 and the geometry of the antenna 9.
f. In the specific embodiment of FIG. 1C the secure element chip 10 is a model called “MicroPass” that is manufactured by INSIDE Contactless, a French company.

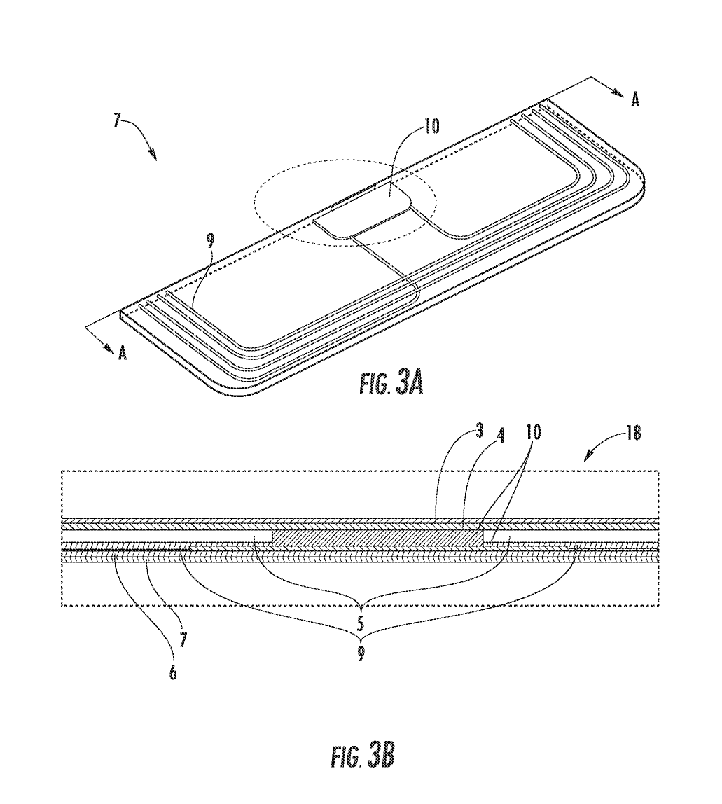

FIGS. 2A and 2B depict a contactless transaction element 11 that is different from the contactless transaction element 1 of FIG. 1. FIG. 2B depicts an exploded view of the contactless transaction element 11, illustrating the following elements:
a. Thin outer protection coating layers 13 and 17 are applied to the contactless transaction element 11. The coating layers 13 and 17 may each be a couple mils (e.g., 0.002″) thick.
b. A microchip/antenna assembly 14 is provided.
c. The microchip/antenna assembly 14 is assembled onto a base substrate 15. The base substrate 15 is typically a couple mils (e.g. 0.002″) thick.
d. A ferrite moderator 16 is provided to enhance the performance of the contactless transaction element 11 when the contactless transaction element is affixed to a mobile device. Because a mobile device itself may create interference and hamper performance of HF radio waves transmitted between the contactless transaction element 11 and an interrogator, it may be beneficial to include a ferrite moderator 16 to help block this interference. This moderator may be a couple mils (e.g., 0.002″) thick.

The embodiment of the contactless transaction element 11 depicted in FIGS. 2A and 2B lacks the filler material 5 that is shown in FIGS. 1A, 1B, and 1C for contactless transaction element 1. The embodiment of the contactless transaction element 11 depicted in FIGS. 2A and 2B may not have a flat surface on one side (the “top” side) due to variations in the thickness of the microchip/antenna assembly 14 and the lack of the filler material 5 that is used in the contactless transaction element 1 of FIGS. 1A, 1B, and 1C. The benefit of the embodiment of FIGS. 2A and 2B is a thinner edge for the contactless transaction element 11 than the edge of the contactless transaction element 1 depicted in FIGS. 1A, 1B and 1C, which is roughly 30 mils (e.g., 0.030″) thick. This thinner edge of the contactless transaction element 11 provides a smoother transition from the contactless transition element region of the payment skin to the edges of the skin.

FIG. 2B also illustrates an embodiment that incorporates an enlarged ferrite monitor 16A. FIG. 2B illustrates that the outer antenna loop 18 of the microchip/antenna assembly 14 defines a first circumscribed area 19 of the antenna of the microchip/antenna assembly 14. The surface area 20 of the enlarged ferrite moderator 16A is approximately fifty percent larger than the circumscribed area 19 of the antenna portion of the microchip/antenna assembly 14. In some embodiments the surface area of an enlarged ferrite moderator is about ten percent larger than the area circumscribed by the outer loop of an antenna. Having a moderator (such as the enlarged ferrite moderator 16a) that is disposed adjacent a mobile device (particularly metal surfaces in a mobile device) and that is at least about ten percent larger than the circumscribed area of an antenna in the contactless transaction element may provide significant benefits by reducing interference caused by the mobile device and by increasing the communication range between the contactless transaction element and an interrogator.

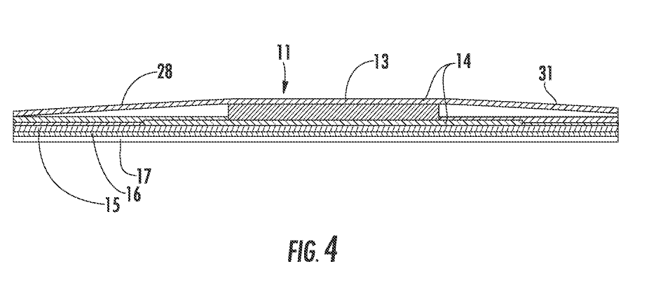

FIG. 3A provides a perspective view of a further embodiment of the contactless transaction element 1 depicted in FIGS. 1A and 1B. The layers of the contactless transaction element 1 are depicted in the cross-sectional view of FIG. 3B, taken through section A-A of FIG. 3A, as follows:
a. The outer protection coating layers 3 and 7 are depicted.
b. The ferrite moderator 4 is depicted.
c. The secure element chip 10 is depicted.
d. The filler material 5 is depicted.
e. The coil antenna 9 is depicted.
f. The base substrate 6 is depicted.

FIG. 4 presents a cross-sectional view of a contactless transaction element similar to the cross-sectional view of FIG. 3B, except that the view in FIG. 4 is a cross-sectional view of the contactless transaction element 11 depicted in FIGS. 2A and 2B. The elements are as follows:
a. The outer coating layers 13 and 17 are depicted.
b. The ferrite moderator 16 is depicted.
c. The microchip/antenna assembly 14 is depicted.
d. The base substrate 15 is depicted.
e. Tapered portions 28 and 31 are depicted. The tapered portions 28 and 31 are created by applying the outer coating layer 13 over the microchip/antenna assembly 14 without including a filler material such as filler material 5 of FIGS. 1B and 2B. These tapered portions 28 and 31 create a contactless transaction element that is thicker in the area of the secure element chip and thinner out toward the edges of the contactless transaction element 11. Typically the contactless transaction element 11 is disposed within a contactless transaction element cavity in a payment skin. The contactless element cavity typically has an edge and the payment skin has one or more tapers (corresponding to tapered portions 28 and 31) that extend from a secure element (e.g., the microchip portion of microchip/antenna assembly 14) to the edge of the contactless transaction element cavity. The outer coating layer 13 may be a flexible material that allows it to conform to the shape of the top of the contactless transaction element 11, creating a protective cover, or the outer coating layer may be a conformal coating material.

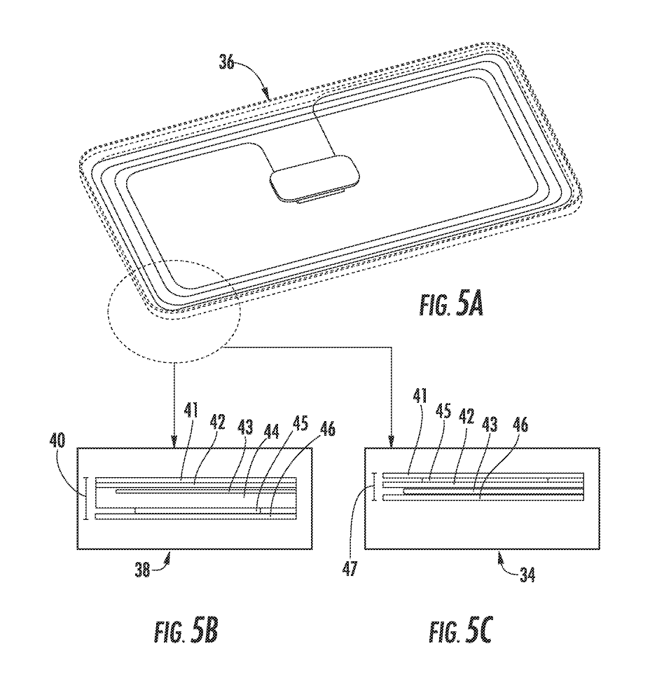

FIG. 5A depicts a further embodiment, a contactless transaction element 36. FIG. 5B depicts a cross-sectional view of one alternative configuration of the edge of the contactless transaction element 36 and FIG. 5C depicts a cross-sectional view of a second alternative configuration of the edge of the contactless transaction element 36. That is, FIG. 5B depicts a cross-sectional view of the edge 38 of an embodiment of the contactless transaction element 1 that is described in FIGS. 1A, 1B, and 1C, whereas FIG. 5C depicts a cross-sectional view of the edge 39 of an embodiment of the contactless transaction element 11 that is depicted in FIGS. 2A and 2B (except that the location of the ferrite moderator in the layered array is changed). The edge 38 that is depicted in FIG. 5B has a thickness 40 that is established by a first outer coating 41, a base substrate 42, an antenna 43, filler material 44, a ferrite moderator 45, and a second outer coating 46. The thickness 40 at the edge 38 of the contactless transaction element is approximately 30 mils (i.e., 0.030″). ISO/IEC 7810 standard published by ISO/IEC (International Organization for Standardization/International Electotechnical Commission) defines a standard card thickness to be 0.76 millimeters or 0.030 inches.

FIG. 5C shows the thickness 47 at the edge 39 that is established by many of the same elements as in edge 38 of FIG. 5B except that there is no filler material 44 in the edge 39. This results in a thickness 47 of approximately 10 mils (i.e., 0.010″). This difference in thickness (thickness 47 compared with thickness 40) is due primarily to the construction of the embodiment of a contactless transaction element 1 shown in FIGS. 1A and 1B compared with the construction of the embodiment of a contactless transaction element 11 depicted in FIGS. 2A and 2B. The difference in construction points out that the edge thickness of a contactless transaction element may thinner than the ISO/IEC 7810 standard. There may be advantages for payment skins in utilizing contactless transaction elements that do not conform to the ISO standard because, as previously indicated, having a thinner edge provides a payment skin with an edge that is less likely to snag on things when the payment skin is applied to a mobile device.

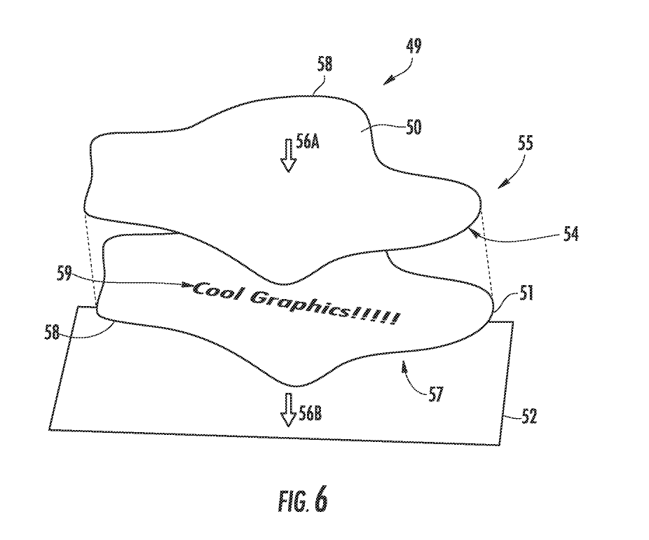

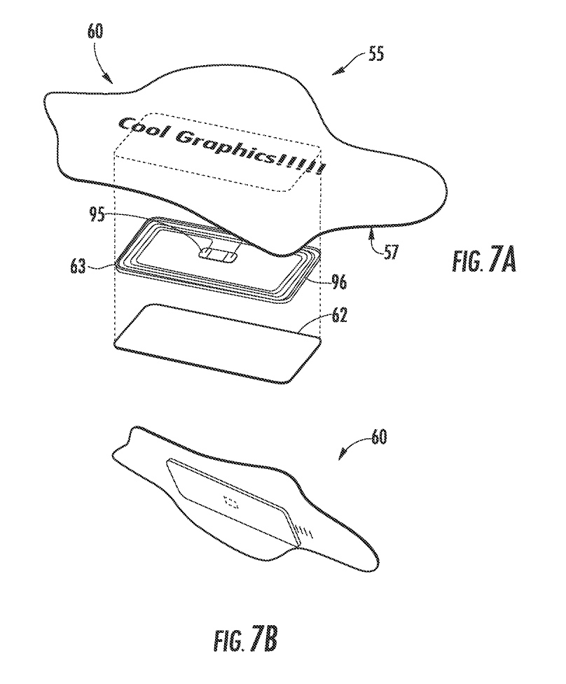

FIG. 6 depicts elements of an embodiment of an overlay 49 that is appropriate for use in fabricating a payment skin. The overlay 49 has three material layers: a transparent over-laminate layer 50, a printed vinyl layer 51, and a backing material 52. The over-laminate layer 50 is generally on the order of 2 mils (e.g., 0.002″) thick. The under-side of the over-laminate layer 50 is coated with a first adhesive 54 which attaches the over-laminate layer to a vinyl layer 51 that is shown below the over-laminate layer 50. The combination of the over-laminate layer 50, the vinyl layer 51 and the first adhesive 54 forms a printed and over-laminated composition 55. The over-laminate layer 50 is a flexible material that is typically applied to the top of the printed vinyl layer 51 in order to provide protection to the vinyl layer 51 after it has been applied to a surface of a mobile device. Arrow 56A indicates the direction in which the over-laminate layer 50 is applied to the vinyl layer 51. The over-laminate layer 50 helps prevent the graphics on the vinyl layer 51 from being scratched, faded or discolored from environmental elements. A specific example of over-laminate at the time of the writing of this document is an over-laminate manufactured by 3M Company under a product number 8519. In the embodiment of FIG. 6 a second adhesive 57 such as COMPLY™ adhesive manufactured by 3M Company is applied on the underside of the vinyl layer 51. The second adhesive 57 is provided for temporarily affixing the vinyl layer 51 to the backing material 52 (in the direction of arrow 56B) and subsequently (after the backing material 52 is removed) for affixing the vinyl layer 51 (with the over-laminate layer 50) to a mobile device. COMPLY™ adhesive has the beneficial characteristic of being able to be applied to an application surface (such as a surface on a mobile device) and then removed and then reapplied (even several times). This allows the person applying the skin to a mobile device to adjust the location of the skin if it is misaligned on the first attempt.

The vinyl layer 51 is typically selected for printability using common printing technology such as ink jet or piezoelectric printing technology. FIG. 6 illustrates that text or graphics of substantially any kind may be printed onto the top surface of the vinyl layer 51. The text or graphics 59 may be created and printed to the vinyl “on-demand” based on the specific preference of the end user for whom a skin is being fabricated. “On-demand” refers to printing and contour cutting after the end user places an order for the mobile device skin. The vinyl material is a flexible material that is designed to conform to the surface to which it is being affixed. The surface may have concave or convex surface features as well as edges or ridges to which the vinyl should conforms. The vinyl is designed to stretch and conform to these areas. The vinyl material is typically on the order of two mils (0.002″) thick. As previously indicated, a second adhesive 57 is typically provided adjacent the under-side of the vinyl layer 51 so that the skin may be affixed to an application surface. This application surface may be any type of material, but in the case of a mobile device skin the material is typically a metallic or a polymeric material. A specific example of the vinyl layer 51 that includes the second adhesive 57 that is appropriate and available as a pre-fabricated combination at the time of the writing of this document is vinyl manufactured by a 3M Company with a product number of IJ180 CV-2. The embodiment in FIG. 6 is typically produced and shipped with the adhesive 57 temporarily adhered to the backing material 52 that is peeled back (and discarded)—typically by the user—during the process of applying a payment skin to a mobile device. The backing material 52 is typically a paper or polycarbonate material. The combination of the vinyl layer 51 (before the graphics 59 are imprinted thereon) and the backing material 52 bonded with the adhesive 57 is an example of a web material onto which graphic designs may be imprinted. The vinyl layer 51 (before the graphics 59 are imprinted thereon) without the backing material 52 or the adhesive 57 is another example of a web material onto which graphic designs may be imprinted. In this latter example of web material, the vinyl layer 51 is bonded to the backing material 52 with the adhesive 57 after printing the graphics 59.

After the vinyl layer 51 is printed and the over laminate layer 50 is applied to the vinyl layer 51 in the direction of the arrow 56A, the composite skin may then be cut out to a specific payment skin boundary 58. In many embodiments the cutting process that is used is kiss-cutting through the over-laminate 50 and vinyl 51 layers while the backing material 52 material remains uncut. This cutting process allows the final mobile device skin to be easily peeled away from the backing material and applied to its specific mobile device. The outline of the cut as depicted by payment skin boundary 58 is specifically configured for the mobile device to which it will be affixed. A mobile device may have many different regions that may be covered by the mobile device skin. Some examples of these regions may be the battery cover region, the back of a mobile device, and the front of a mobile device. These may be different physical mobile device skins that are applied to a single mobile device. The cut outline of each region is cut “on-demand” based on the specific device to which it is being applied. On-demand refers to cutting after the card holder or mobile device owner places an order for the mobile device skin.

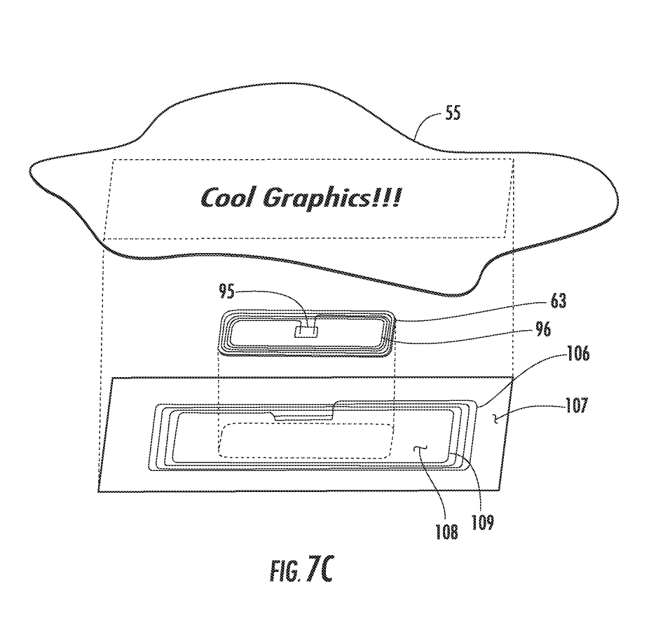

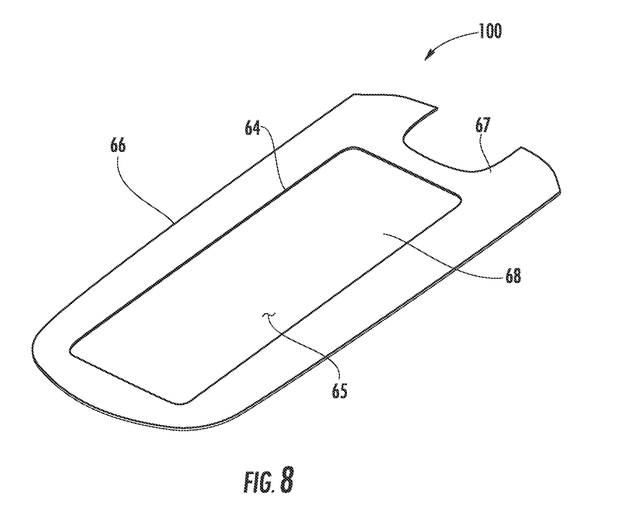

The various parts of an embodiment of a contactless payment skin 60 are shown in FIGS. 7A and 7B. The layers shown in FIG. 7A are applied to one another in a vertical direction to form the payment skin 60 shown in FIG. 7B, which is a view of the reverse side of a payment skin 60 compared with the view of FIG. 7A. The components of a payment skin 60 of FIG. 7A are as follows:
a. A printed and over-laminated composition (e.g., the printed and over-laminated composition 55 of FIG. 6).
b. A contactless transaction element 63 that may be constructed as shown in FIGS. 1A, 1B, and 1C or FIGS. 2A and 2B. The contactless transaction element 63 has a secure element 95 and a first antenna 96. The first antenna 96 is operatively connected to the secure element 95 and is provided for receiving and transmitting radio frequency signals comprising transaction data.
c. Double sided adhesive layer 62 that is applied to the under-side of the contactless transaction element 63. This double sided adhesive layer 62 is also affixed to the mobile device to which the payment skin 60 is being affixed. The adhesive layer 62 is typically a thin layer that may be approximately 2 mils (0.002″) thick.

FIG. 7C depicts an assembly that includes a second antenna 106 disposed on a substrate 107. The contactless transaction element 63 is disposed within an inner area 108 that is circumscribed by the innermost loop 109 of the second antenna 106. The second antenna 106 is disposed adjacent the first antenna and is inductively coupled to the first antenna 96 of the contactless transaction element 63. By such inductive coupling the overall field strength and read range of the system may be increased. Importantly, the two antennas 96 and 106 may not be physically wired together. As shown in FIG. 7C, the smaller of the coil antennas (96) may be placed inside of the larger coil antenna (106) in order for the contactless transaction element 63 to achieve the equivalent larger field range of the larger antenna (106). This arrangement is particularly beneficial in payment skins because the larger antenna shape may be customized or selected to better fit the outside dimensions of the payment skin while the contactless region may be constrained to its original size. The large inductive coil can also be assembled to the system at any time without doing a physical “wiring” to the system. One embodiment is shown above and has the larger inductive coil mounted to a thin substrate that may also serve as an adhesive layer between the payment skin and the mobile device to which it is mounted.

FIG. 8 depicts a mobile device contactless payment skin 100. This specific payment skin 100 is designed for the battery cover region of a Samsung A870 mobile device. A cut outline 66 is specific to that particular region of this mobile device. Skin material 67 is provided, and in the example of FIG. 8, the skin material does not include on-demand printed graphics. A contactless transaction element region 68 is provided and in this embodiment the contactless transaction element region 68 is visible on the exterior of the skin material 67. The skin material 67 is designed to conform to the surface to which it is affixed, including a contactless transaction element, so even though the contactless transaction element itself in underneath the skin material 67 as shown in this view, the shape of the contactless transaction element is visible on the exterior of the skin material 67. The most distinct portion of the contactless transaction element that shows through the skin material 67 is the edge 64 of the contactless transaction element. The height 65 of the edge of the protrusion is determined by the height of the edge of the contactless transaction element. It is an advantage to minimize the height 65 of the protrusion to give a more integrated look and feel to the combination of the payment skin and the mobile device to which it is affixed. A contactless transaction element may be created similar to the embodiment depicted in FIGS. 2A and 2B for this purpose.

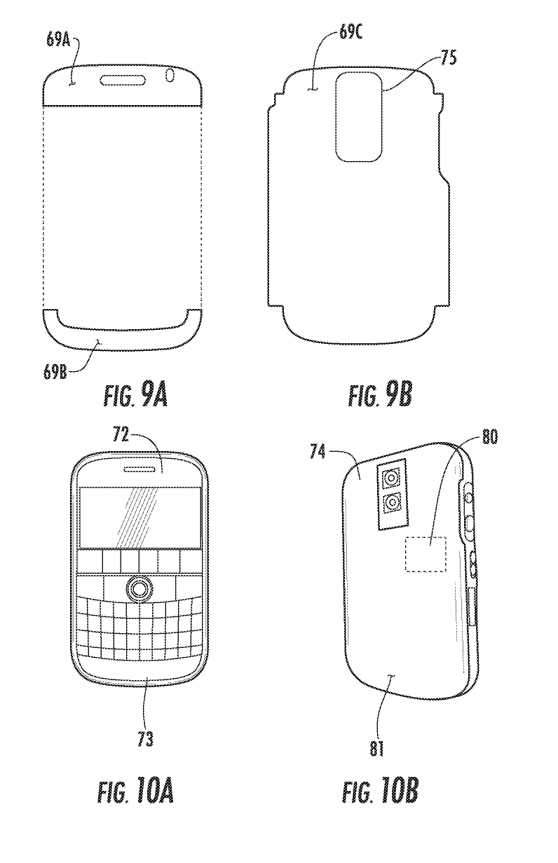

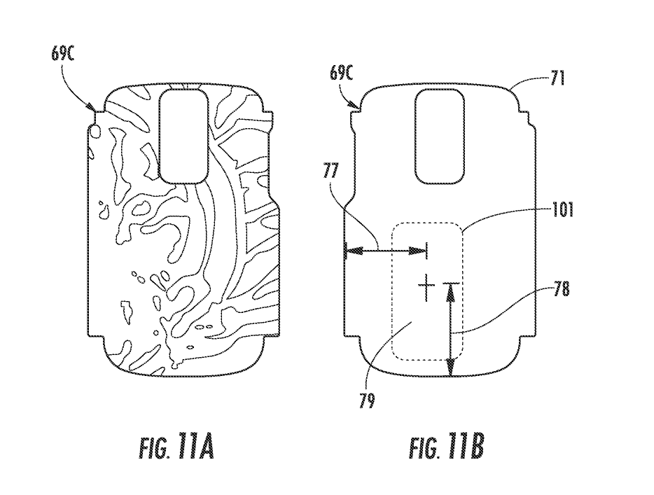

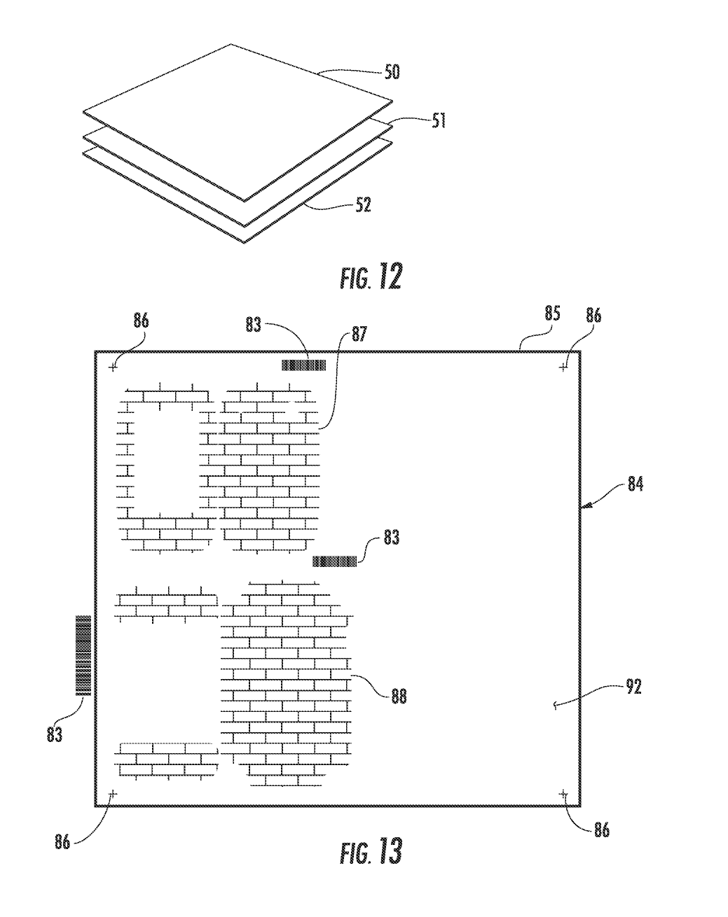

FIGS. 9A and 9B depict a payment skin having three segments. FIG. 9A depicts two of the segments (69A and 69B) and FIG. 9B depicts the third segment 69C. FIGS. 10A and 10B depict the top front 72, bottom front 73, and the back 74 of the mobile device to which the payment skin is to be affixed. The mobile device is a BlackBerry Bold 9000 made by RIM (Research In Motion). As indicted in FIGS. 9A, 9B, 10A, and 10B, the geometry of the segments of the payment skin provide an intuitive indication of the proper placement and alignment of the payment skin segments on the mobile device. For example the hole 75 that is cut in the third segment 69C depicted in FIG. 9B conforms to the camera 76 on the back 74 of the mobile device shown in FIG. 10B. Further intuitive indications provide for a properly-oriented application of payment skin segments 69 and 70 on the top front 72 and the bottom front 73 of the mobile device.

Referring again to FIG. 10B, it is important to note the location 80 of the cell phone antenna in the mobile device. The antenna location 80 is just one example of where an antenna for handset communication may be placed inside the inner workings of the handset. This region and its location within the handset are designed by the manufacturer of the particular mobile device with the constraints and environment of the entire mobile handset itself in mind. Because this is an antenna that is designed for communication with mobile communication towers, its performance is affected by the environment it is in which includes any objects that are near or attached to the mobile handset itself It is important that the effects of any article being affixed to the handset and its makeup are studied and its location is selected properly for the handset in order that the article has a minimal amount of effect on the function performance of the handset.

FIG. 11A depicts the outer surface of the back segment 69C of the payment skin from FIG. 9B and FIG. 11B depicts the under surface of the back segment 69C. In this embodiment the back segment 69C provides a contactless transaction element region 101 (FIG. 11B) of the payment skin. The location of the contactless transaction element region 101 is determined by taking into account the design of the handset itself. The specific X-distance 77 and Y-distance 78 may be determined for different mobile devices by empirical testing. Because of the intuitive indicators that assist the end user in positioning the payment skin on the mobile device, the contactless transaction element is properly positioned on the mobile device. In some embodiments several peel-away payment skin boundaries may have substantially the same geometric shape, such as the same size rectangle with rounded corners, but the peel-away payment skins are designed for different mobile devices. In such embodiments the peel-away payment skin boundaries that have substantially the same geometric shape may have contactless transaction element regions at different contactless transaction element locations within the substantially same geometric shape. The different locations reflect the optimal contactless transaction element location for the different mobile devices.

The main elements of interference that the contactless transaction element may impart on the mobile handset functional performance are any metallic regions that are associated directly to the contactless transaction element such as the ferrite moderator 45 as shown in FIG. 5B, or any metal that may be in other layers of the contactless transaction element such as the double-sided adhesive layer 62 shown in FIG. 7A. These high concentrations of metal create the most problems for functional performance of the mobile handset antenna itself with wireless communications with communication towers. It has been shown in tests that re-location of these metal areas of the contactless transaction element of as little as one cm had significant effect on mobile handset antenna functional performance.

The main elements of interference that the mobile handset may impart on the contactless transaction element functional performance would be any metallic regions and the concentration of those regions to which the contactless transaction element is affixed. For example, a mobile device back material 81 depicted in FIG. 10B may be a metal casing that may have an effect on the contactless transaction element functional performance with an external interrogator. It is shown in tests that metal may affect the read range of 13.56 MHZ RFID transponders by effectively de-tuning the antenna of the transponder or interrogator. Placing the contactless transaction element strategically on a surface generally may help mitigate the effects of the metal surface. Specifically placing a contactless transaction element toward the edge of a metal surface area as opposed to placing a contactless transaction element in the middle of a metal surface area exposes less metal to the field of the interrogator and provides a stronger, more tuned field to the contactless transaction element. This enhances performance by providing a longer reading distance away from the transponder.

Also, it was previously noted herein that having a moderator (such as the enlarged ferrite moderator 16a depicted in FIG. 7C) that is disposed adjacent a mobile device (particularly metal surfaces in a mobile device) and that is at least about ten percent larger than the circumscribed area of an antenna in the contactless transaction element provides significant benefits in reducing interference caused by the mobile device and increasing the communication range between the contactless transaction element and an interrogator. In some embodiments a moderator may be included that extends beyond the boundaries of the contactless transaction element region 101 substantially all the way to the edge 71 that defines the perimeter shape of the payment skin. That is, the perimeter shape of the moderator substantially conforms to the perimeter shape of the payment skin. In some embodiments an orifice (hole) may be provided in the moderator for minimizing interference with a cellular communication with the mobile device attributable to the moderator. For example, an orifice or hole may be provided in the moderator that substantially conforms in shape and position to the location (e.g., location 80 depicted in FIG. 10B) of the cell phone antenna in the mobile device.

FIG. 12 illustrates a perspective exploded view of a material that may be used to fabricate skins for payment skins Depicted is a vinyl layer 51 that, in FIG. 12, is shown with a design already printed onto it. Also depicted is an over-laminate layer 50. The over-laminate layer 50 is a transparent, protective layer that is flexible. The over-laminate layer 50 has an adhesive backing that allows it to be applied in a room temperature lamination process over the printed vinyl layer 51 after the vinyl layer 51 has gone through a printing process. The vinyl layer 51 is the middle layer that is printable and is also a flexible material that generally conforms to the contour of a surface to which it is applied. In the embodiment of FIG. 12 the vinyl layer 51 is coated with an adhesive that affixes it to contoured surfaces. A disposable backing material 52 is provided as the bottom layer to facilitate handling of a skin prior to affixing it to a mobile device. The backing material 52 is peeled off to apply the printed vinyl layer 51 (with the over-laminate layer 50) to a mobile device.

Referring again to FIG. 12, during a reverse or “flip” contour cutting operation, such as that previously described for forming a contactless transaction element region in a skin, the material in FIG. 12 is placed into the cutter upside down (compared with the orientation depicted in FIG. 12), such that the knife blade first penetrates the backing material 52 to cut the backing material at the proper location and contour for the contactless transaction element that is to be used in the payment skin while leaving both the vinyl layer 51 and the over-laminate layer 50 intact. A contactless transaction element cavity is formed in the payment peel-away by removing the backing material along that contour of the contactless transaction element. Note that the contactless transaction element cavity generally is a region on the vinyl layer 51 that is defined only by the removed backing material (and does not include an indentation in the vinyl material). However, in some embodiments the contactless transaction element cavity may include an indented (embossed) feature in the vinyl material. This contactless transaction element cavity provides proper placement of the contactless transaction element that is affixed to the underside of the vinyl layer 51.

FIG. 13 provides an example of an assembly of a set of skins for mobile devices formed on planar sheet material 84. The planar sheet material 84 is an example of a web material and a planar substrate. The planar sheet material 84 is a vinyl having skin graphics printed on a web first side 92. Specifically, graphics 87 for a Palm Pre are shown as well as graphics 88 for an Apple iPhone 3G. The graphics 87 and 88 are examples of payment skin imprints that have a different geometric shape and are laid out in a pattern and printed on the web first side 92 (which is also a first side of a planar substrate, e.g., sheet material 84, and which is also a skin first side). A reference frame 85 is shown. Additional reference marks 86 are shown at the corners of the reference frame 85. The reference frame 85 and/or the reference marks 86 are provided to assist in alignment and orientation of a cutting machine that is used to cut the boundaries of peel-away payment skins. In the embodiment of FIG. 13 a barcode 83 is provided for tagging the two peel-away payment skins represented by graphics 87 and 88 with a destination identifier corresponding to their recipient(s).

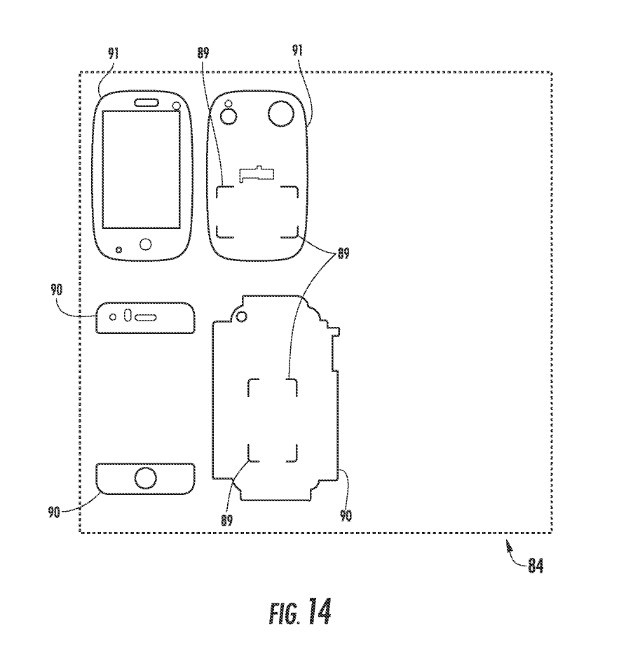

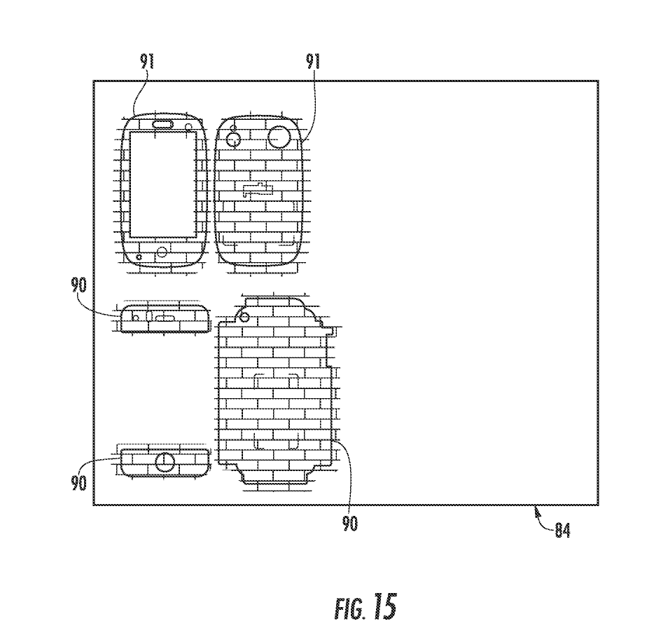

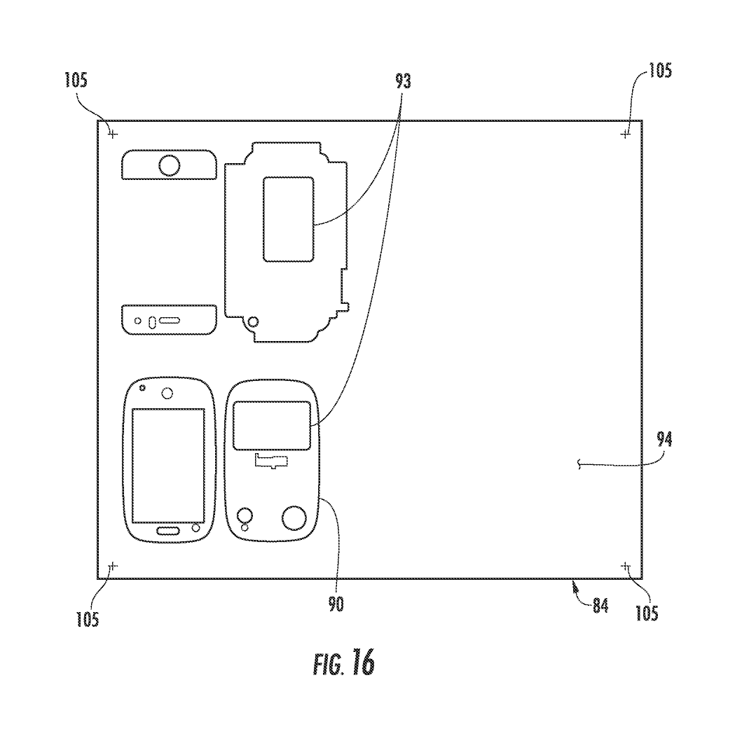

Examples of peel-away cut line boundaries 90 and 91 formed on the planar sheet material 84 are shown in FIG. 14. These boundaries 90 and 91 define a first side of a peel-away skin and are produced by a cutting machine such as with the previously-described kiss-cutting procedure. FIG. 14 also illustrates how relief cuts 89 may be used to alleviate bunching and wrinkling of the vinyl when it is applied with a comparatively thick contactless transaction element disposed underneath it. The relief cuts 89 in this figure are provided at four corners of the location to which the contactless transaction element will be applied. The relief cuts 89 also serve to allow the vinyl to apply properly to the contoured surface without wrinkling or bunching around the corners of the contactless transaction element. Typically, the relief cuts 89 are formed as kiss-cuts that penetrate the over-laminate layer 50 and vinyl layer 51 depicted in FIG. 12, but leave the backing material 52 intact. FIG. 14 shows cut line boundaries 91 for the Palm Pre handset as well as cut line boundaries 90 for the iPhone 3G handset and the associated relief cuts 89 placed in the proper location for the installation of the contactless transaction element for each of these mobile devices. FIG. 15 illustrates how the cut line boundaries 90 and 91 may be aligned with the graphic images of FIG. 13.

In FIG. 16 the printed sheet in FIG. 15 has been reversed or “flipped” around the horizontal axis. In FIG. 16 a backing material 94 is facing out of the page. The backing material 94 forms a web second side (which is also the second side of the planar substrate, e.g., sheet material 84. The peel-away cut line boundaries 90 and 91 define a peel-way skin second side when the skins represented by graphics 87 and 88 are peeled away from the backing material 94. FIG. 16 has been created with transparency in order to illustrate an alignment procedure and how features on the web second side may match features on the web first side 92. In practice the planar sheet material 84 is typically opaque such that features on one side are not visible on the opposing side. Reference marks 105 are shown. These reference marks 105 coincide with the reference marks 86 formed on the web first side 92 of the vinyl planar sheet material 84 as shown in FIG. 13. One way to accurately position the reference marks 105 is to make through cuts or slits in material from the web first side 92 and then use an ink pen to draw the marks on the second side of the vinyl backing. These reference marks 105 are important because they allow the cutting machine to align properly to the print in order to create the contactless transaction element boundary cut 93 into the backing material 94 as shown in FIG. 16 at a location where a contactless transaction element is to be installed. The contactless transaction element boundary 93 cut is a kiss-cut that penetrates on the backing material 52, but leaves the vinyl layer 51 and over-laminate layer 50 intact. This procedure allows the inside of the contactless transaction element cut lines (boundary 93) to be peeled back exposing the adhesive of the vinyl layer 51. This exposed region of vinyl and adhesive may be used to align and adhere a contactless transaction element to the vinyl layer 51.

During the application process of the finished contactless payment skin product by the consumer, the entire contour cut skin vinyl layer (and the over-laminate layer 50) is peeled away from the backing material 52. The contactless transaction element is already “stuck” or disposed adjacent the vinyl layer 51 and also releases from the backing material 52 along the contour cut of the vinyl layer 51. The skin is then applied to the appropriate mobile device of the consumer through intuitive alignment of matching the shape of the contour to the device itself. As a result, the contactless transaction element is also placed into the correct location with respect to the mobile device antenna, battery, and other impeding components within the mobile device.

Various attributes of embodiments described herein include the following:
Ideally, the graphical images and the physical shape options for a payment skin are tightly integrated (matched) between the mobile device and the contactless payment skin by providing a custom shaped skin that matches the end user's specific mobile device. This is distinguished from general-purpose, non-customized, stickers for a mobile device.
It is important to provide an effective and efficient adhesion or affixing matching area between a payment skin and the mobile device to which it will be affixed. Preferably the payment skin is designed to cover all of a particular section on a particular mobile device model, so that the area of adhesion between the contactless payment skin and mobile device is greater and stronger than a general purpose contactless sticker that is not customized for each particular mobile device.
Some embodiments described herein provide a synergistic interconnection between a payment credential encoded in a secure element in a payment skin and the mobile device to which it is affixed. For example, software applications may be executed on the mobile device that may enhance the logical connection between the secure element and the verification process that is operating.
It is beneficial in various embodiments that the alignment of a contactless transaction element to a location external to the mobile device be optimized. This location of the contactless transaction element with respect to the casing of the handset can have functional effects on both the performance of the mobile device communication signals with wireless communication towers as well as have functional effects on the performance and read range of the contactless transaction element with external interrogators. As a result, various embodiments described herein facilitate the proper alignment of a contactless transaction element to a mobile device through a contoured vinyl sticker that intuitively affixes to the correct location on a mobile device in a single or polar fashion.
Ideally, there is no limitation on the number of different models of mobile devices for which payment skins may be provided. As a practical matter, to maintain optimal performance of the secure element and the mobile device to which it is affixed, it is important that proper alignment of the secure element and associated hardware items be maintained. Research and design costs related to this consideration may limit, as a practical matter, the number of mobile devices for which a payment skins may be provided.

The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. A method for fabricating a plurality of peel-away payment skins for a plurality of mobile devices, comprising:
(a) compiling a first database portion of payment skin options comprising
(1) a plurality of skin outlines where each skin outline is associated with at least one of the plurality of mobile devices,
(2) a plurality of skin graphics where each skin graphic is associated with at least one of the plurality of skin outlines, and
(3) a plurality of contactless transaction element boundaries where each contactless transaction element boundary is associated with at least one of the plurality of skin outlines;
(b) compiling a second database portion of a plurality of payment skin orders, each payment skin order comprising a recipient indicator and a payment skin order indicator where each payment skin order indicator is associated with one of the payment skin options in the first database portion;
(c) laying out a pattern comprising a plurality of payment skin imprints, where each skin imprint is associated with one of the payment skin order indicators in the second database portion and represents the skin outline and the skin graphic in the first database portion that is associated with that payment skin indicator;
(d) printing the pattern of the skin imprints on a front side of a web material with an automated printing machine;
(e) cutting with an automated cutting machine a peel-away payment skin in the web material for each payment skin imprint disposed on the front side of the web material, such that each peel-away payment skin comprises the payment skin outline and the payment skin graphic that is associated with that payment skin imprint;
(f) for each payment skin imprint in the pattern disposed on the front side of the web material, forming a contactless transaction element region on a back side opposed to the front side of the web material such that the contactless transaction element region conforms substantially to the contactless transaction element boundary in the first database portion that is associated with the payment skin outline that is associated with that payment skin imprint in the pattern;
(g) tagging each peel-away payment skin with a destination identifier corresponding to the recipient indicator associated with the payment skin order associated with the payment skin imprint associated with that peel-away payment skin; and
(h) separating the plurality of peel-away payment skins from each other.

2. The method of claim 1 wherein step (e) comprises kiss-cutting a peel-away payment skin.

3. The method of claim 1 wherein step (f) comprises forming a contactless transaction element region using kiss-cutting.

4. The method of claim 1 wherein step (f) comprises forming a contactless transaction element region by embossing.

5. The method of claim 1 further comprising the step of accessing the contactless transaction element region to form a contactless transaction element cavity in each payment skin imprint and inserting in that contactless transaction element cavity a contactless transaction element that is associated with the recipient indicator that is associated with the payment skin order that is associated with the contactless transaction element region that is associated with that payment skin imprint.

6. The method of claim 1 where in the step of forming a contactless transaction element region comprises forming a contactless transaction element region at a location that (a) minimizes a reduction of radio frequency power attributable to a metallic element in the mobile device and that (b) maximizes a data communication range of a secure element when the secure element is disposed in the contactless transaction element region.

7. The method of claim 1 wherein the first database portion of payment skin options further comprises:
(4) at least one coupled inductance antenna layout associated with at least one payment skin outline;
and wherein the method further comprises a step of affixing an antenna to at least one peel-away payment skin such that the antenna conforms substantially to the coupled inductance antenna layout that is associated with the at least one payment skin outline that is associated with that payment skin imprint.

8. An assembly of skins for mobile devices comprising:
a planar sheet material having a web first side and an opposing web second side;
a plurality of peel-away payment skins each being defined by a peel-away payment skin boundary that is cut in the sheet material, where each peel-away payment skin boundary has a different geometric shape and where each peel-away payment skin comprises:
a skin first side corresponding to the web first side;
a skin second side corresponding to the web second side;
a skin graphic disposed within the peel-away payment skin boundary of the peel-away payment skin on the skin first side; and
a contactless transaction element region having a contactless transaction element location and a contactless transaction element boundary that is formed on the skin second side within the peel-away payment skin boundary.

9. The assembly of skins of claim 8 wherein a portion of the peel-away payment skin boundaries have substantially the same geometric shape and the portion of the peel-away payment skin boundaries that have substantially the same geometric shape comprise contactless transaction element regions at different contactless transaction element locations within the substantially same geometric shape.

10. A payment skin for a mobile device comprising:
a substantially planar substrate having a first side and an opposing second side;
a skin imprint disposed on the first side;
a contactless transaction element cavity disposed on the second side;
a secure element disposed within the contactless transaction element cavity;
a first antenna for receiving and transmitting radio frequency signals comprising transaction data, the first antenna being disposed adjacent the secure element and operatively connected to the secure element; and
a second antenna disposed adjacent the first antenna, the second antenna being inductively coupled to the first antenna.

11. The payment skin of claim 10 wherein the contactless element cavity has an edge and the payment skin comprises a taper extending from the secure element to the edge.

12. The payment skin of claim 10 wherein the contactless element cavity comprises a relief cut.

13. A payment skin for a mobile device comprising:
a substantially planar substrate having a first side and an opposing second side;
a skin imprint disposed on the first side;
a contactless transaction element cavity disposed on the second side;
a secure element disposed within the contactless transaction element cavity;
an antenna for receiving and transmitting radio frequency signals comprising data, the antenna having a first circumscribed area and the antenna being disposed adjacent the secure element and operatively connected to the secure element; and
a moderator for reducing interference with the radio frequency signals, the moderator having a second circumscribed area that is at least about ten percent larger than the first circumscribed area and the moderator being disposed adjacent the antenna.

14. The payment skin of claim 13 wherein the planar substrate has first perimeter shape and the moderator has a second perimeter shape that substantially conforms to the first perimeter shape.

15. The payment skin of claim 13 wherein the moderator comprises an orifice for minimizing cellular communication interference attributable to the moderator.

16. A method of optimizing the location of a secure element having a data communication range and optimizing the location of a metallic element in a payment skin for a mobile wireless device having an antenna for reception of a radio frequency signal at a designated frequency, the method comprising:
(a) evaluating a reduction in power of the radio frequency signal collected by the antenna at the designated frequency by testing a plurality of locations for the metallic element in the skin to establish an optimal metallic element location that minimizes the reduction in power of the radio frequency signal at the designated frequency attributable to the metallic element to determine an optimal metal element location; and
(b) evaluating a reduction of the data communication range of the secure element by testing a plurality of locations for the secure element in the skin to establish an optimal secure element location that maximizes the data communication range of the secure element to determine an optimal secure element location.

17. The method of claim 16 where step (a) is performed last.

18. The method of claim 16 where step (b) is performed last.
